(19) United States
(12) Patent Application Publication
(10) Pub. No.: US 2002/0065910 A1
(43) Pub. Date: May 30, 2002

(54) Method, system, and program for providing access time information when displaying network addresses

(76) Inventor: Rabindranath Dutta, Austin, TX (US)

Correspondence Address: David Victor, Esq, Ste. 501, 1180 South Beverly Dr., Los Angeles, CA, 90035, US

(21) Appl. No.: 09/726,268

(22) Filed: Nov. 30, 2000

(51) Int. Cl. G06F 15/173; G06F 15/16

(52) U.S. Cl. 709/224; 709/203

(57) ABSTRACT

Provided is a system, method, and program for rendering network addresses of files capable of being downloaded over a network on an output device. A list of previously accessed network addresses is generated. An access time rating is associated with each network address indicating a relative time to access a file from the network address.

### BACKGROUND OF THE INVENTION

1. Field of the Invention

The present invention relates to a method, system, and program for providing access time information when displaying network addresses and, in particular, when displaying network addresses in a web browser program.

2. Description of the Related Art

One of the rapidly expanding sources of information and documentation is the “World Wide Web” (WWW) or Internet. Content servers which provide access to information over the Internet typically utilize the Hypertext Transfer Protocol (HTTP). Oftentimes, textual information is implemented in a standard page description language such as the Hypertext Markup Language (HTML). HTML provides basic document formatting and allows the developer to specify “links” to other servers and files. Use of an HTML-compliant client browser involves specification of a link via a Uniform Resource Locator or “URL”. Users may access an HTML document from over the Internet and then use an HTML or web browser to display the downloaded file. The advantage of such HTML browsers is that they can execute on many different computing environments and numerous types of operating systems. Thus, an information provider need only code a document in HTML to make that document available to just about every computing platform that provides Internet access.

A user may access an HTML page by typing the URL address in an address field in the browser, selecting a URL saved in a “Favorites” or “Bookmark” list of user selected URLs, or selecting a URL displayed as a hypertext link or icon in a displayed HTML page. The HTML link represents a URL address of another related HTML page of information. When a user selects a URL address using one of the above three methods, the browser generates an HTTP GET request to access the HTML page at the URL, and then separately issues GET requests to access any objects embedded in the parent HTML page, such as images, graphics, Java applets, Active X controls, etc.

One common complaint of Internet users is the delay experienced when downloading a page, and any embedded objects in the page, and then rendering the downloaded HTML pages and embedded files on a display monitor. The “total access time”, as that term is used herein, refers to the time to both download an HTML page from a remote server, and all embedded files, and the time to complete rendering the downloaded HTML page and embedded files on the output device, e.g., display monitor, printer, speakers, etc. Download times are particularly important for users having relatively slower modems, such as a 28.8K or 56.6K telephone modem. In such case, it may take twenty to thirty seconds, or more, to download a page. It has been observed that the more time needed to download an HTML page, the increased likelihood that the user will terminate the access attempt and proceed to request a different URL. Moreover, download times are also a significant issue for users accessing the Internet through a Internet Service Provider (ISP) that charges users based on time usage. For instance, many wireless Internet connections charge fees based on a per unit of time basis for accessing the Internet.

Notwithstanding the importance of access times, in the prior art, the only way the user can avoid pages that have excessive download times is to hope to remember that a particular URL has an unduly high total access time and avoid such URLs. However, the more pages users access when “surfing” the Internet, the more likely users will not remember pages that have particularly high total access times. In such case, users may repeatedly request pages that take unduly long to access and find themselves repeatedly waiting a long time for the page to download and render. If users tire of waiting for the page to download, then they have to terminate the download operation after having wasted the time waiting for the page to download.

Thus, there is a need in the art for Internet web browsers to provide information that may allow users to better select which URL pages to download.

### SUMMARY OF THE PREFERRED EMBODIMENTS

Provided is a method, system, and program for rendering network addresses of files capable of being downloaded over a network on an output device. A list of previously accessed network addresses is generated. An access time rating is associated with each network address indicating a relative time to access a file from the network address.

In further embodiments, an access time indicator for one network address is based on the access time rating, wherein there are at least two different access time indicators for different access time ratings. The access time indicator is rendered when rendering the network address.

In still further embodiments, rendering the network address comprises displaying the network address on a display monitor and rendering the access time indicator comprises altering the display of the network address on the display monitor. Still further, the access time indicator may comprise a color in which to display the network address on the display monitor.

Still further, the file accessed from the network address may comprise a page to display on a display monitor. In such case, the network address processed comprises a network address included in the page to display within the displayed page and the access time rating is based on a time to download the page from over the network.

Yet further, when generating the list of previously accessed network addresses with access time ratings, each time the page is downloaded from the network address, a determination is made of a time to download the page from over the network. The determined time is stored with the network address and an expected access time is calculated from the stored determined times for each network address. The access time rating is determined from the expected access time.

Preferred embodiments provide a technique to maintain access time information with a list of previously accessed URLs or network addresses. This information is used to determine an access time rating. The access time rating for the URL is then used to determine an access time indicator to render when rendering the URL network address to provide the user information on the access time for that particular URL. For instance, the access time indicator may comprise a color in which the URL is displayed, indicating a relative access time that is based on the past history of access times for that URL. When provided such access time information, the user may then avoid those URLs that are expected to take particularly long to download. This feature is especially useful in environments were the communication interface is slow or the user is being charged per unit of time for accessing the Internet

### BRIEF DESCRIPTION OF THE DRAWINGS

Referring now to the drawings in which like reference numbers represents corresponding parts throughout:

FIG. 1 illustrates a computing environment in which preferred embodiments are implemented;

FIG. 2 illustrates browser components in accordance with preferred embodiments of the present invention;

FIG. 3 illustrates fields in the URL history list entries in accordance with preferred embodiments of the present invention; and

FIGS. 4, 5, and 6 illustrate logic implemented in the browser application to display URL addresses with information indicating a relative access time for the URL address in accordance with preferred embodiments of the present invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

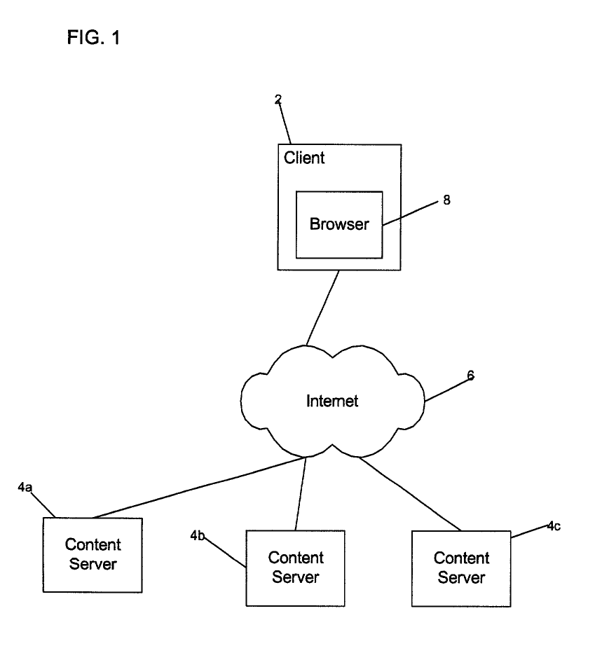

FIG. 1 illustrates a network computing environment in which preferred embodiments are implemented. A client computer 2 communicates with one or more content servers 4a, b, c providing content in the form of HTML pages or other content, e.g., images, PDF files, video, Java programs,** sound files, etc., to requesting clients over the Internet 6 in a manner known in the art. The term “pages” as used herein refers to any type of data structure known in the art capable of presenting information, wherein the information may be implemented in any media format known in the art, such as text, audio, video images, still images, animation, three-dimensional images, etc. The client computer 2 includes a Web browser program 8 e.g., NETSCAPE Communicator, the MICROSOFT Internet Explorer, Spry Mosaic, NCSA Mosaic, Lynx, Opera, GNUscape Navigator, etc.**, that includes HTTP software to function as an HTTP client to transfer document requests to the content servers 4a, b, c. In alternative embodiments, the content may be distributed over a network other than the Internet, such as a LAN or Intranet. The client computer 2 may comprise any computing device known in the art, such as a personal computer, laptop computer, hand held computer, server, cellular phone, telephony device, network appliance, etc. **NETSCAPE is a registered trademark of the Netscape Communications Corporation; WINDOWS and MICROSOFT are registered trademarks of Microsoft Corporation; OS/2 is a registered trademark of International Business Machines Corporation; JAVA is a trademark of Sun Microsystems, Inc.

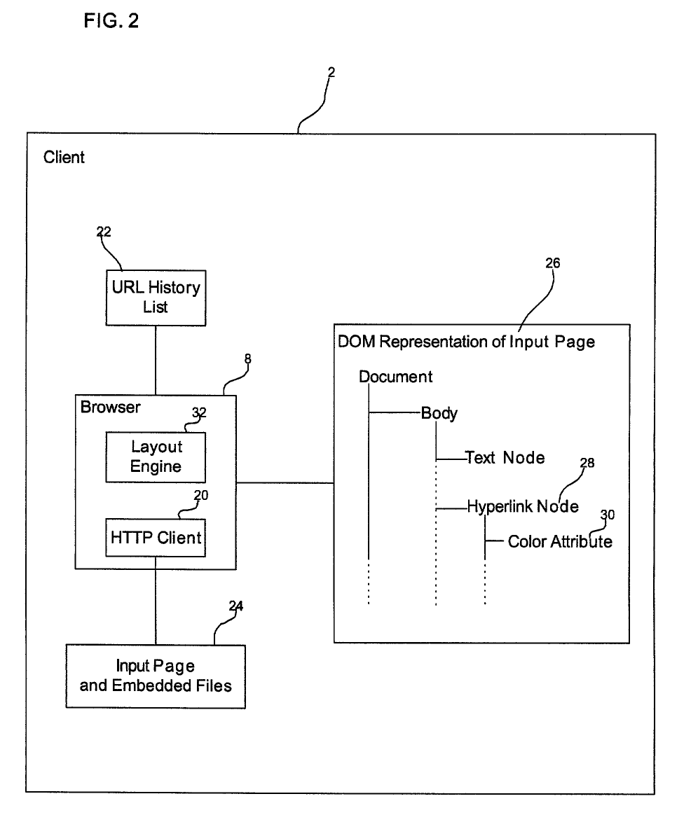

FIG. 2 illustrates further detail of the browser 8 and its interaction with various data structures within the client 2. The browser 8 includes an HTTP client 20 to request and receive pages from the content servers 4a, b, c over the Internet 6. The browser 8 stores information on the URL of each page retrieved in a URL history list 22. The URL history list 22 may comprise a separate file or comprise part of another file the browser 8 uses to store information, such as an operating system registry file. The browser 8 retrieves an input page and any embedded files 24 from one of the content servers 4a, b, c that is in HTML, extended markup language (XML), or other language used for rendering content.

The browser 8 would then proceed to generate a DOM object representation 26 of the input page 24 in a manner known in the art where nodes are created from the components of the input page 24. In preferred embodiments, the browser 8 would create hyperlink link nodes 28 for each hypertext link or icon whose selection generates a request for a URL provided with the link. Each hyperlink node 28 would include a color attribute 30 indicating a color in which the hyperlink text or icon is to be displayed. A “hyperlink”, as that term is used herein, comprises either a hypertext link to another URL or a link embedded within an icon that causes the browser 8 to generate a GET request for the URL when the icon is selected The hyperlink nodes may be child nodes of text nodes or any other node within the DOM representation 26, or at other levels in the hierarchical DOM representation 26 of the input page 24 and embedded files.

The browser 8 further includes a layout engine 32 that processes the DOM representation 26 of the input page to render the content of the DOM representation 26 onto an output device, such as a display monitor, to present the page. The output device used by the browser 8 may comprise a display screen, audio speakers, printer, etc. For instance, the page may be written in a voice markup language that generates output to an audio device. The layout engine 32 may comprise any layout engine known in the art for rendering the content of a DOM representation, such as the Mozilla layout engine, Internet Explorer layout engine, etc.

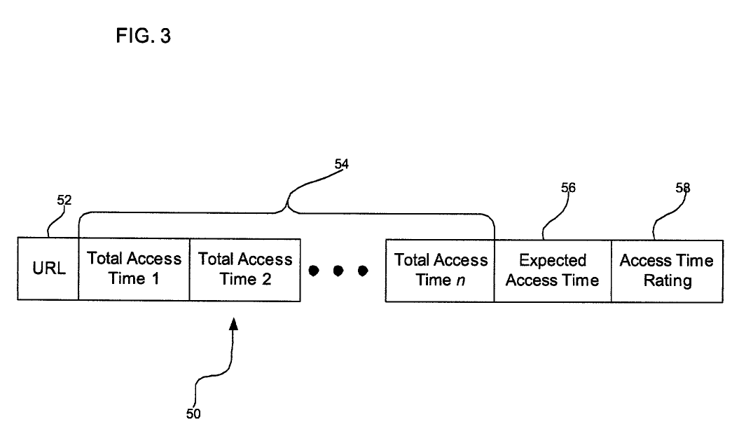

FIG. 3 illustrates fields for each entry in the URL history list 22. Each URL entry 50 in the URL history list 22 includes:

URL field 52: Indicates the URL address of the accessed page.

List of Total Access Times 54: Provides the total access time for each access of the page at the address identified in the URL field 50 within a predetermined time period, e.g., a couple of weeks, etc. Total access times that predate the predetermined time, i.e., are stale, may be discarded.

Expected Access Time 56: Provides an estimation of the expected access time for the page based on the total access times 54. For instance, the expected access time 56 may comprise the average or median of the expected access times 54, or some variation thereof, such as a weighted average based on the age of the total access times 54.

Access Time Rating 58: Indicates an access time rating 58 relative to the expected access times of other URLs based on some predefined criteria. For instance, a user or developer may specify ratings based on ranges of access times. The time values for the ranges may be dependent on the communication device the client 2 uses, e.g., 28.8K or 56.6K telephone modem, cable modem, Digital Susbscriber Line (DSL), etc. Alternatively, the time values of the ranges may be based on a statistical distribution or normalization, e.g., bell curve, of the expected access times for all the URLs, so that a first rating comprises all expected access times within a certain percentile range, a second rating comprises expected access times within an adjacent percentile range, etc. The access time rating 58 indicates whether the expected access time 56 is slow, fast or average relative to the other access times.

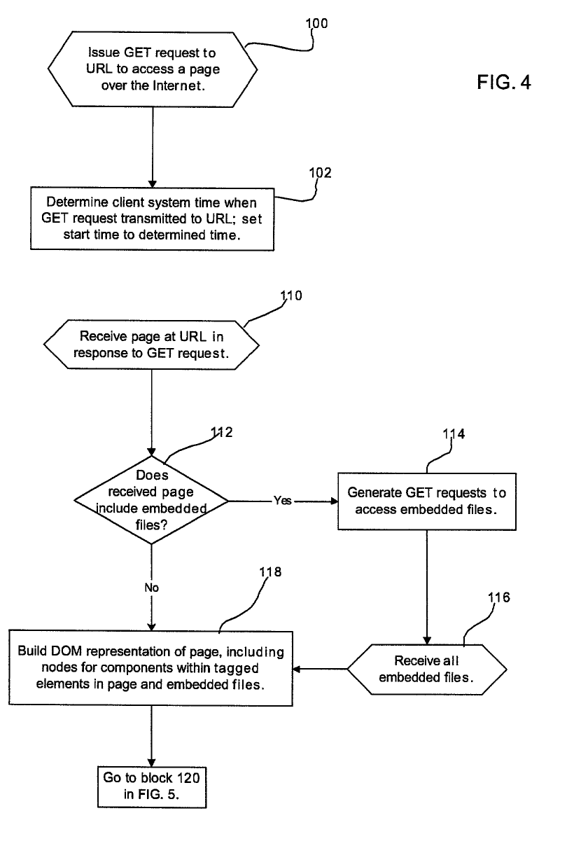

FIGS. 4, 5, and 6 illustrate logic implemented in the browser 8 code to display hyperlinks in accordance with preferred embodiments of the present invention. The browser 8 would include code and programs included in Web browser programs known in the art and the additional logic of FIGS. 4, 5, and 6 to implement the operations of the preferred embodiments. Control begins at block 100 in FIG. 4 with the browser 8 issuing an HTTP GET request to a URL to access a page at the URL over the Internet 6. The browser 8 then determines (at block 102), using a standard operating system command, the client 2 system time at the time the GET request was transmitted to the URL, and sets the start time to the determined time. Upon receiving (at block 110) the page at the URL from the content server 4a, b, c in response to the GET request, the browser 8 determines (at block 112) whether the received page includes embedded files. If so, the browser 8 generates (at block 114) GET requests to access each embedded file in the received page.

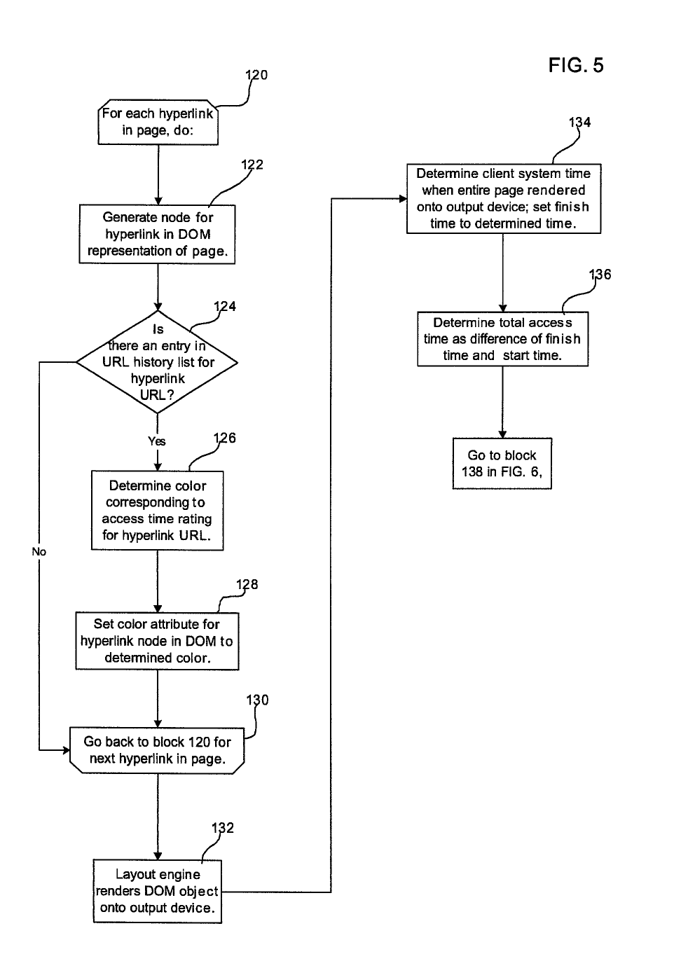

If the received page 24 does not include any embedded files or after receiving (at block 116) all the embedded files, the browser 8 builds (at block 118) a DOM representation 26 of the received page 24, including nodes for tagged elements within the input page 24, in a manner known in the art. Control then proceeds to block 120 in FIG. 5 to perform a loop from blocks 120 to 130 to generate nodes in the DOM representation 26 of the input page for each hyperlink in the input page 24. At block 122, the browser 8 generates a node 28 for the hyperlink in the DOM representation 26 of the input page. If (at block 124) there is an entry in the URL history list 22 for the URL included in the hyperlink, then the browser 8 determines (at block 126) a color corresponding to the access time rating 58 for the entry in the URL history list 22 for the URL. The browser 8 may maintain colors corresponding to different ranges of access time ratings. For instance, for a high access time rating indicating a lengthy access time, the browser 8 may use the color red to indicate that accessing the page at the hyperlink URL takes considerable time to download; for a low access time rating indicating relatively quick downloads, the browser 8 may use the color green to indicate that accessing the page at the hyperlink URL is accessed relatively quickly. Additional colors may be associated with different access time ratings, indicating an average access time, etc. Further, a browser 8 user may be able to select the colors to associate with different access time ratings. After determining the color, the browser 8 sets (at block 128) a color attribute 30 for the hyperlink node 28 in the DOM representation 26 to the determined color to cause the hyperlink to be displayed in the determined color. From block 128 or if (at block 124) there is not an entry in the URL history list 22 for the accessed URL, then control proceeds (at block 130) back to block 120 if there are further hyperlinks in the input page 24.

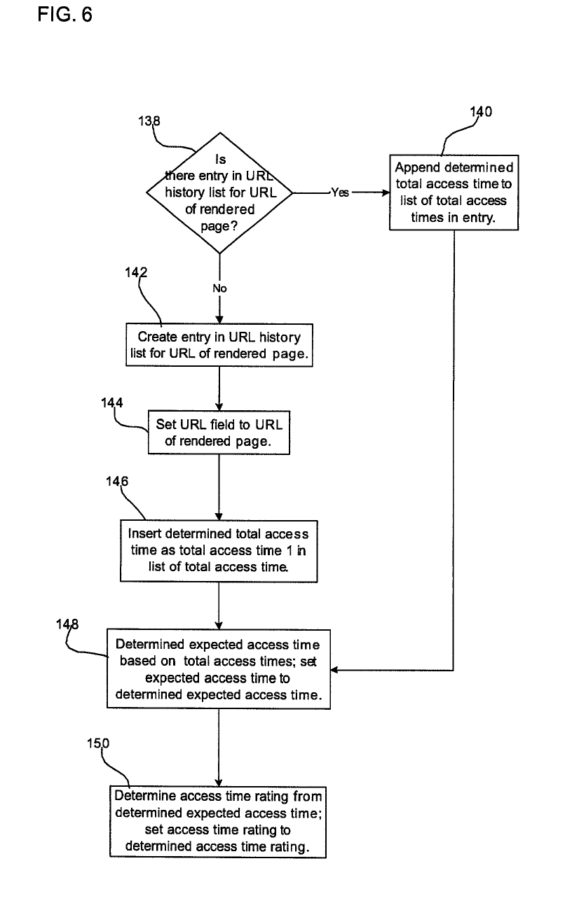

After generating the DOM representation 26 of the input page, the browser 8 layout engine 32 (at block 132) renders the elements of the DOM object 26 onto the client 2 output device, e.g., display monitor. The browser 8 determines (at block 134) the client 2 system time as of the time the entire page is rendered (at block 134) onto the output device. The finish time is set to the determined system time. The browser 8 then determines (at block 136) the total access time to download and render the page as the difference of the finish time and the start time. Control then proceeds to block 138 in FIG. 6 to update the URL history list 22 with the total access time for the URL page just downloaded and rendered.

At block 138 in FIG. 6, the browser 8 determines whether there is an entry in the URL history list 22 having a URL value 52 that is the same as the URL of the page just rendered. If so, then the browser 8 appends the determined total access time to the total access time list 54. Otherwise, if there is no URL entry in the URL history list 22 for the accessed URL, then the browser 8 creates (at block 142) an entry 50 in the URL history list 22 for the URL of the just rendered page. The URL field 52 is set (at block 144) to the URL of the rendered page. The browser 8 then inserts (at block 146) the determined total access time as the first total access time 54. From blocks 140 or 148, the browser 8 determines (at block 148) the expected access time based on the total access times 54 in the entry 50, and sets the expected access time field 56 to the determined expected access time. As discussed, the expected access time may be calculated as an average, median, weighted average or other statistical value based on the total access times 54. Further, if certain of the total access times were measured on a date that predates a date limit, then those older total access times are discarded when determining the expected access time. The access time rating 56 is determined (at block 150) from the determined expected access time in the manner discussed above.

The logic of FIGS. 4-6 determines how to display hyperlinks in a rendered page. The preferred embodiment URL history list 22 may also be used to determine the color to display URL addresses in other contexts. For instance, when displaying a list of user saved “Favorite” or “Bookmark” URLs, the browser 22 may determine the access time rating 56 to determine the color to use to display each URL in the “Favorite” or “Bookmark” list of saved URLs. In fact, the entry 50 may include a field indicating the color to use when displaying the URL. Moreover, current web browsers, such as the Microsoft Internet Explorer, provide an autocomplete feature that displays previously accessed URLs as the user types in a URL address in the address field that includes as a substring the address characters the user has typed. The user may then select one of the displayed previously accessed URLs. When displaying the URLs in the autocomplete list the browser 8 may display the URLs in the list in the color indicated in the entry 50 for that URL, or based on the access time rating 56. In this way, in alternative contexts, previously accessed URLs may be displayed in different colors to indicate the relative expected access time for that URL, e.g., fast, medium, slow.

Preferred embodiments provide a technique for providing a web browser user information on an expected total access time for a URL when the URL is displayed in a page, in a pre-selected “Favorite” or “Bookmark” list, or in an autocomplete list. In preferred embodiments, the browser 8 displays the URL address in different colors indicating different expected access times, such as green for short access time, red for unduly long access time, etc. This information may allow the user to determine whether to select the URL and endure a long wait The preferred embodiment technique for providing information on an expected access time for a URL is particularly useful for situations where the communication modem is slow, the web site is generally slow, or where the user is charged on a time basis for Internet access. In these cases, the user may be especially interested in factoring access times into the decision of whether to select a URL.

Following are some alternative implementations for the preferred embodiments.

The preferred embodiments may be implemented as a method, apparatus or article of manufacture using standard programming and/or engineering techniques to produce software, firmware, hardware, or any combination thereof. The tern “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In preferred embodiments, the color information to apply to display the URL is maintained as an attribute for a hyperlink node in a DOM representing the page accessed from the content server 4a, b, c. In alternative embodiments, the browser 8 may process the page without generating a DOM representation of input page. For instance, the browser 8 may directly render the page from the input page onto the output display without preparing a DOM document. In such case, the browser 8 would still determine the access time ratings 58 and corresponding color to use when displaying the URLs within the browser.

In preferred embodiments, expected access time information was conveyed by displaying the URL addresses in different colors connoting different relative expected access times. In alternative embodiments, the browser 8 may use other output to indicate a relative expected access rate for a URL. For instance, a certain sound may be generated when the user selects or proceeds to select a URL associated with a slow access time rating as opposed to a high access time rating. Alternatively, different graphics may be used to display URLs having different access time ratings. Still further, the expected access time may be displayed next to the URL hyperlink, such as when the ULR hyperlink is displayed in a bookmark or favorites list. In such case, the access time indicator would comprise the expected access time or the actual access time rating.

In preferred embodiments, access time information was maintained for URLs. in alternative embodiments, access time information may be maintained for any type of network address, including network addresses in formats other than the URL format.

Preferred embodiments were described with respect to accessing and generating a DOM object for pages conforming to the HTML file format However, alternative file formats for building web-like pages may be used, such as Dynamic Hypertext Mark-Up Language (DHTML), the Extensible Markup Language (XML), Cascading Sytle Sheets, any other Standard Generalized Markup Language (SGML), Scalable Vector Graphics (SVG), or any other language known in the art for creating interchangeable, structured documents. Further, any version of HTML may be used, including version 2.0, 3.2, 4.0, etc. In yet further embodiments, the requested file may be in any other file format, i.e., other than an SGML type format, capable of being displayed or otherwise downloaded and displayed in the browser application.

Preferred embodiments were described with respect to a network environment in which pages are provided to a client from a server over a network, such as the Internet. In preferred embodiments, the program downloading and displaying pages from over the network was implemented in a Web browser type program. However, the preferred embodiment technique for displaying network addresses may be implemented in any type of viewer program, not just a Web browser, that is capable of downloading and displaying the content of pages from over a network such as the Internet.

The foregoing description of the preferred embodiments of the invention has been presented for the purposes of illustration and description. It is not intended to be exhaustive or to limit the invention to the precise form disclosed Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for rendering network addresses of files capable of being downloaded over a network on an output device, comprising:
generating a list of previously accessed network addresses; and
associating an access time rating with each network address in the list indicating a relative time to access a file from the network address.

2. The method of claim 1, further comprising:
determining an access time indicator for one network address based on the access time rating, wherein there are at least two different access time indicators for different access time ratings; and
rendering the access time indicator when rendering the network address on the output device.

3. The method of claim 2, wherein the rendered access time indicator comprises an access time rendered with the network address.

4. The method of claim 2, wherein the output device comprises a display monitor, wherein rendering the network address comprises displaying the network address on a display monitor and wherein rendering the access time indicator comprises altering the display of the network address on the display monitor.

5. The method of claim 4, wherein the access time indicator comprises a color in which to display the network address on the display monitor.

6. The method of claim 2, wherein the output device comprises a display monitor, wherein the file accessed from the network address comprises a page to display on the display monitor, wherein the network address to render comprises a network address included in the page to display within the displayed page, and wherein the access time rating is based on a time to download the page from over the network.

7. The method of claim 6, wherein the access time rating is further based on a time to render the downloaded page as output on the display monitor.

8. The method of claim 6, wherein the time to download the page further comprises a time to download any files embedded in the page that are rendered with the page.

9. The method of claim 6, wherein generating the list of previously accessed network addresses with access time ratings comprises:
each time the page is downloaded from the network address, determining a time to download the page from over the network;
storing each determined time with the network address;
calculating an expected access time from the stored determined times for each network address; and
determining the access time rating from the expected access time.

10. The method of claim 6, wherein the page is implemented in a markup-language including tagged elements, further comprising:
generating a document object including nodes for the tagged elements;
generating a node for each network address included in the page; and
generating an attribute for each network address node implementing the access time indicator determined form the network address, wherein the page is rendered from the document object.

11. The method of claim 2, wherein rendering the access time indicator when rendering the processed network address further comprises:
receiving characters of a network address a user inputs into an address field displayed on the output device;
determining a set of network addresses from the list of previously accessed network addresses that begin with the received characters;
determining the access time indicator for each of the determined network addresses in the set based on the access time rating associated with each network address; and
rendering the determined access time indicator for each network address with the network address in a list of network addresses, wherein a user is capable of selecting one of the rendered network addresses to substitute for the received characters to enter into the address field.

12. The method of claim 2, wherein rendering the access time indicator when rendering the processed network address further comprises:
accessing a list of selected network addresses;
determining the access time indicator for each of the network addresses in the list of selected network addresses based on the access time rating associated with each network address; and
rendering the determined access time indicator with each network address in the list of selected network addresses.

13. A system for rendering network addresses of files capable of being downloaded over a network on an output device, comprising:
means for generating a list of previously accessed network addresses; and
means for associating an access time rating with each network address in the list indicating a relative time to access a file from the network address.

14. The system of claim 13, further comprising:
means for determining an access time indicator for one network address based on the access time rating, wherein there are at least two different access time indicators for different access time ratings; and
means for rendering the access time indicator when rendering the network address.

15. The system of claim 14, wherein the rendered access time indicator comprises an access time rendered with the network address.

16. The system of claim 14, wherein the output device comprises a display monitor, wherein the means for rendering the network address performs displaying the network address on the display monitor and wherein the means for rendering the access time indicator performs altering the display of the network address on the display monitor.

17. The system of claim 16, wherein the access time indicator comprises a color in which to display the network address on the display monitor.

18. The system of claim 14, wherein the output device comprises a display monitor, wherein the file accessed from the network address comprises a page to display on the display monitor, wherein the network address to render comprises a network address included in the page to display within the displayed page, and wherein the access time rating is based on a time to download the page from over the network.

19. The system of claim 18, wherein the access time rating is further based on a time to render the downloaded page as output on the display monitor.

20. The system of claim 18, wherein the time to download the page further comprises a time to download any files embedded in the page that are rendered with the page.

21. The system of claim 18, wherein the means for generating the list of previously accessed network addresses with access time ratings performs:
each time the page is downloaded from the network address, determining a time to download the page from over the network;
storing each determined time with the network address;
calculating an expected access time from the stored determined times for each network address; and
determining the access time rating from the expected access time.

22. The system of claim 18, wherein the page is implemented in a markup-language including tagged elements, further comprising:
means for generating a document object including nodes for the tagged elements;
means for generating a node for each network address included in the page; and
means for generating an attribute for each network address node implementing the access time indicator determined form the network address, wherein the page is rendered from the document object.

23. The system of claim 14, wherein the means for rendering the access time indicator when rendering the processed network address further performs:
receiving characters of a network address a user inputs into an address field displayed on the output device;
determining a set of network addresses from the list of previously accessed network addresses that begin with the received characters;
determining the access time indicator for each of the determined network addresses in the set based on the access time rating associated with each network address; and
rendering the determined access time indicator for each network address with the network address in a list of network addresses, wherein a user is capable of selecting one of the rendered network addresses to substitute for the received characters to enter into the address field.

24. The system of claim 14, wherein the means for rendering the access time indicator when rendering the processed network address further performs:
accessing a list of selected network addresses;
determining the access time indicator for each of the network addresses in the list of selected network addresses based on the access time rating associated with each network address; and
rendering the determined access time indicator with each network address in the list of selected network addresses.

25. An article of manufacture for rendering network addresses of files capable of being downloaded over a network on an output device, wherein the article of manufacture comprises code implemented in a computer readable medium capable of causing a processor to perform:
generating a list of previously accessed network addresses; and
associating an access time rating with each network address in the list indicating a relative time to access a file from the network address.

26. The article of manufacture of claim 25, further comprising code capable of causing the processor to perform:
determining an access time indicator for one network address based on the access time rating, wherein there are at least two different access time indicators for different access time ratings; and
rendering the access time indicator when rendering the network address.

27. The article of manufacture of claim 26, wherein the rendered access time indicator comprises an access time rendered with the network address.

28. The article of manufacture of claim 26, wherein the output device comprises a display monitor, wherein rendering the network address comprises displaying the network address on the display monitor and wherein rendering the access time indicator comprises altering the display of the network address on the display monitor.

29. The article of manufacture of claim 28, wherein the access time indicator comprises a color in which to display the network address on the display monitor.

30. The article of manufacture of claim 25, wherein the output device comprises a display monitor, wherein the file accessed from the network address comprises a page to display on the display monitor, wherein the network address to render comprises a network address included in the page to display within the displayed page, and wherein the access time rating is based on a time to download the page from over the network.

31. The article of manufacture of claim 30, wherein the access time rating is further based on a time to render the downloaded page as output on the display monitor.

32. The article of manufacture of claim 30, wherein the time to download the page further comprises a time to download any files embedded in the page that are rendered with the page.

33. The article of manufacture of claim 30, wherein generating the list of previously accessed network addresses with access time ratings comprises:
each time the page is downloaded from the network address, determining a time to download the page from over the network;
storing each determined time with the network address;
calculating an expected access time from the stored determined times for each network address; and
determining the access time rating from the expected access time.

34. The article of manufacture of claim 30, wherein the page is implemented in a markup-language including tagged elements, further comprising code capable of causing the processor to perform:
generating a document object including nodes for the tagged elements;
generating a node for each network address included in the page; and
generating an attribute for each network address node implementing the access time indicator determined form the network address, wherein the page is rendered from the document object.

35. The article of manufacture of claim 26, wherein rendering the access time indicator when rendering the processed network address further comprises:
receiving characters of a network address a user inputs into an address field displayed on the output device.
determining a set of network addresses from the list of previously accessed network addresses that begin with the received characters;
determining the access time indicator for each of the determined network addresses in the set based on the access time rating associated with each network address; and
rendering the determined access time indicator for each network address with the network address in a list of network addresses, wherein a user is capable of selecting one of the rendered network addresses to substitute for the received characters to enter into the address field.

36. The article of manufacture of claim 26, wherein rendering the access time indicator when rendering the processed network address further comprises:
accessing a list of selected network addresses;
determining the access time indicator for each of the network addresses in the list of selected network addresses based on the access time rating associated with each network address; and
rendering the determined access time indicator with each network address in the list of selected network addresses.
